(19) United States
(12) Patent Application Publication
(10) Pub. No.: US 2016/0098517 A1
(43) Pub. Date: Apr. 7, 2016

(54) APPARATUS AND METHOD FOR DETECTING INTERNAL TANDEM DUPLICATION

(71) Applicant: SAMSUNG SDS CO., LTD., Seoul (KR)

(72) Inventors: In-Ho PARK, Hanam-si (KR); Choong-Hyun SUN, Ansan-si (KR); Hong-Seok YUN, Seoul (KR); Seung-Mook LEE, Seoul (KR)

(73) Assignee: SAMSUNG SDS CO., LTD., Seoul (KR)

(21) Appl. No.: 14/872,369

(22) Filed: Oct. 1, 2015

(30) Foreign Application Priority Data
Oct. 1, 2014 (KR) 10-2014-0132374

(51) Int. Cl. G06F 19/22

(52) U.S. Cl. CPC G06F 19/22

(57) ABSTRACT

According to an illustrative embodiment, provided herein is an internal tandem duplication (ITD) detection apparatus which includes a breakpoint identification unit for identifying two breakpoints in a reference genome sequence based on a plurality of reads, each of which partially matches the reference genome sequence; and an ITD detection unit for generating an ITD reference sequence which includes a base sequence portion spanning between the two breakpoints in the reference genome sequence and a sequential repetition of the base sequence portion.

### BACKGROUND

1. Field

Embodiments disclosed herein are related to a method for detecting internal tandem duplication (ITD).

2. Discussion of Related Art

ITD refers to a genetic mutation having fragments of repeated patterns. Particularly, ITD generated in a FMS-related tyrosine kinase 3 (FLT3) gene is found in 20% or more of patients having acute myeloid leukemia (AML), and is an important factor to be considered for selecting an anticancer method.

Various methods for detecting only the ITD of a FLT3 gene have been developed. Different from these methods, a next generation sequencing (NGS) technology is widely being used nowadays to simultaneously detect various types of mutations related to cancer development. As NGS has been developed, an effective analysis of a base sequence has become possible. The NGS method randomly divides a DNA (deoxyribonucleic acid) sample into a plurality of DNA fragments and sequences the DNA fragments at once. Normally, an NGS sequencer is able to output a base sequence of each of tens of millions to hundreds of millions of short DNA fragments from a DNA sample of a certain organism. An entire base sequence (i.e. a genome sequence) which represents the genetic information of the organism may be generated from fragmentary base sequences.

One of the methods for obtaining the genome sequence is appropriate for a case in which a reliable standard genome sequence of the organism exists (for example, when the organism is a human being). The method reconstructs a genome sequence of the organism while mapping and aligning fragments of a base sequence to a standard genome sequence. The genome sequence of the organism may have a part different from the standard genome sequence (i.e. genomic variation), and the part may be detected in a process of reconstructing the genome sequence. However, additional analysis may be required for detecting a genomic variation of long length or a complex pattern using short fragments of a base sequence. Particularly, an ITD mutation of a FLT3 gene has a length of 10 to 300 bp (base pair), and there is a difficulty in detecting a long ITD mutation using short fragments of a base sequence. In addition, conventional clinical attempts to detect ITD in a FLT3 gene of a patient having AML based on NGS are also attempts merely applying a method for detecting other forms of mutations and are inadequate to promptly and accurately detect only an ITD mutation.

### RELATED ART DOCUMENT

### Patent Document

International Unexamined Patent Publication No. WO 2014/071272 A1

### SUMMARY

Embodiments disclosed herein provide a new method which is appropriate for detecting internal tandem duplication (ITD) in a genome sample such as a DNA sample.

According to an illustrative embodiment, there is provided an ITD detection apparatus, including: a breakpoint identification unit for identifying two breakpoints in a reference genome sequence based on a plurality of reads, each of which partially matches the reference genome sequence; and an ITD detection unit for generating an ITD reference sequence which includes a base sequence portion spanning between the two breakpoints in the reference genome sequence and a sequential repetition of the base sequence portion.

The ITD detection apparatus may further include a read mapping unit for mapping the plurality of reads with the reference genome sequence to identify a matching portion and a nonmatching portion of each of the plurality of reads, wherein the matching portion may match the reference genome sequence, and the nonmatching portion may not match the reference genome sequence.

Both ends of each of the plurality of reads may be positioned at the matching portion and the nonmatching portion, respectively.

The read mapping unit may also map a plurality of related reads among the plurality of reads to the ITD reference sequence to generate a mapping result, and one end of a matching portion of each of the plurality of related reads may be mapped at one of the two breakpoints.

The read mapping unit may generate the mapping result based on the length of each of the plurality of related reads and the length of one portion of each of the plurality of related reads, and the one portion may not match the ITD reference sequence.

The breakpoint identification unit may also obtain the plurality of reads sequenced from a genome sample, and the ITD detection unit may also detect an ITD mutation in the genome sample based on the mapping result.

The ITD detection unit may also change the ITD reference sequence by including one or more different sequential repetitions of the base sequence portion in the ITD reference sequence, and the read mapping unit may also repeat mapping of the plurality of related reads with respect to the changed ITD reference sequence.

The breakpoint identification unit may also identify a plurality of positions in the reference genome sequence based on the plurality of reads to determine a plurality of candidate breakpoints in the reference genome sequence, and the matching portion of each of the plurality of reads may have an end mapped at one of the plurality of positions.

The breakpoint identification unit may determine each of the plurality of candidate breakpoints as a corresponding position among the plurality of positions based on a total number of related reads among the plurality of reads; the length of the longest related read among the related reads; a total number of all possible pairs each having a first base positioned in one nonmatching portion of the related reads and a second base positioned in another nonmatching portion of the related reads; and a total number of the same base pairs among the all possible pairs, and each of the related reads may have an end mapped at the corresponding position, and the first base and the second base may be mapped at the same position in the reference genome sequence.

The breakpoint identification unit may identify the two breakpoints among the plurality of candidate breakpoints based on a position difference between the two breakpoints.

According to an illustrative embodiment, there is provided a method for detecting ITD, the method including: identifying two breakpoints in a reference genome sequence based on a plurality of reads, each of which partially matches the reference genome sequence; and generating an ITD reference sequence which includes a base sequence portion spanning between the two breakpoints in the reference genome sequence and a sequential repetition of the base sequence portion.

The method for detecting ITD may further include mapping the plurality of reads to the reference genome sequence to identify a matching portion and a nonmatching portion of each of the plurality of reads, wherein the matching portion may match the reference genome sequence, and the nonmatching portion may not match the reference genome sequence.

Both ends of each of the plurality of reads may be positioned at the matching portion and the nonmatching portion, respectively.

The method for detecting ITD may further include mapping a plurality of related reads among the plurality of reads to the ITD reference sequence to generate a mapping result, and one end of a matching portion of each of the plurality of related reads may be mapped at one of the two breakpoints.

The mapping of the plurality of related reads may include generating the mapping result based on the length of each of the plurality of related reads and the length of one portion of each of the plurality of related reads, and the one portion may not match the ITD reference sequence.

The method for detecting ITD may further include obtaining the plurality of reads sequenced from a genome sample; and detecting an ITD mutation in the genome sample based on the mapping result.

The method for detecting ITD may further include changing the ITD reference sequence by including one or more different sequential repetitions of the base sequence portion in the ITD reference sequence; and repeating mapping of the plurality of related reads with respect to the changed ITD reference sequence.

The identifying of the two breakpoints may include identifying a plurality of positions in the reference genome sequence based on the plurality of reads to determine a plurality of candidate breakpoints in the reference genome sequence, and the matching portion of each of the plurality of reads may have an end mapped at one of the plurality of positions.

The identifying of the two breakpoints may further include determining each of the plurality of candidate breakpoints as a corresponding position among the plurality of positions based on a total number of related reads among the plurality of reads; the length of the longest related read among the related reads; a total number of all possible pairs each having a first base positioned in one nonmatching portion of the related reads and a second base positioned in another nonmatching portion of the related reads; and a total number of the same base pairs among the all possible pairs, wherein each of the related reads may have an end mapped at the corresponding position, and the first base and the second base may be mapped at the same position in the reference genome sequence.

The identifying of the two breakpoints may further include identifying the two breakpoints among the plurality of candidate breakpoints based on a position difference between the two breakpoints.

According to an illustrative embodiment, there is provided a computer program combined with hardware and stored in a medium to execute the method for detecting ITD described above.

### BRIEF DESCRIPTION OF THE DRAWINGS

The above and other objects, features and advantages of the preset disclosure will become more apparent to those of ordinary skill in the art by describing in detail exemplary embodiments thereof with reference to the accompanying drawings, in which:

FIG. 1 is a view illustrating extracting read sequences from a DNA sample including ITD and mapping the extracted read sequences to a reference sequence;

FIG. 2 is a flow chart illustrating a process of detecting ITD according to an illustrative embodiment;

FIG. 3 is a view for describing identifying a breakpoint of a sequence according to an illustrative embodiment;

FIG. 4 is a view for describing an ITD reference sequence generated according to an illustrative embodiment; and

FIG. 5 is a view illustrating an ITD detection apparatus according to an illustrative embodiment.

### DETAILED DESCRIPTION OF EXEMPLARY EMBODIMENTS

Hereinafter, specific embodiments of the preset disclosure will be described with reference to the accompanying drawings. A detailed description below is provided to assist in a comprehensive understanding of a method, an apparatus and/or a system described in the present specification. However, the detailed description is only illustrative, and the preset disclosure is not limited thereto.

In describing embodiments of the preset disclosure, when a specific description of prior art related to the preset disclosure is deemed to make the gist of the preset disclosure unnecessarily vague, the detailed description thereof will be omitted. In addition, terms to be mentioned below are terms defined by considering a function in the preset disclosure, and may vary in accordance with intentions or customs etc. of a user or an operator. Therefore, the terms should be defined based on whole content throughout the present specification. Terms used in the detailed description are only for describing embodiments of the preset disclosure, and should not limit the preset disclosure. A singular expression includes a plural meaning unless clearly used otherwise. In the present description, expressions such as “include” or “have” are for referring to certain characteristics, numbers, steps, operations, components, some or combinations thereof, and it should not be construed as eliminating the presence or possibility of one or more different characteristics, numbers, steps, operations, components, some or combinations thereof besides those described.

The following terms used in describing illustrative embodiments in the present specification will be described.

First, “base sequence” is a sequence or a sequenced catalog of bases, and is information or data representing an order of bases. Consequently, it may be said that bases cataloged as above are positioned in the base sequence in the order of the bases. Generally, a total number of different bases possible in a base sequence is finite. For example, each base in a DNA base sequence may be indicated by one of four alphabet letters A, C, G, and T. In addition, a base having a particular position in a DNA base sequence may be unclear in terms of which alphabet letter among A, C, G, and T should be used for indication thereof due to various reasons (for example, a sequencing error and/or an error in a DNA sample), and the base may be indicated by another letter (for example, N) in this case. The length of a base sequence signifies a total number of bases in the base sequence. In addition, since a base sequence portion is one portion or a sub-sequence of a certain base sequence and is a fragmentary base sequence which is shorter than the base sequence, the length of the base sequence portion is a total number of bases in the portion.

In addition, “read sequence” (may be shortened and also be called “read”) is a fragmentary base sequence output from a genome sequencer. The length of a read may vary in accordance with types of the genome sequencer, and may approximately be 35 to 500 bp, as an example.

Furthermore, “reference genome sequence” (may be shortened and also be called “reference sequence”) signifies a standard base sequence referred for generating an entire base sequence from reads. An illustrative base sequence alignment algorithm may complete a genome sequence of a genome sample by mapping reads sequenced from the genome sample to a reference sequence.

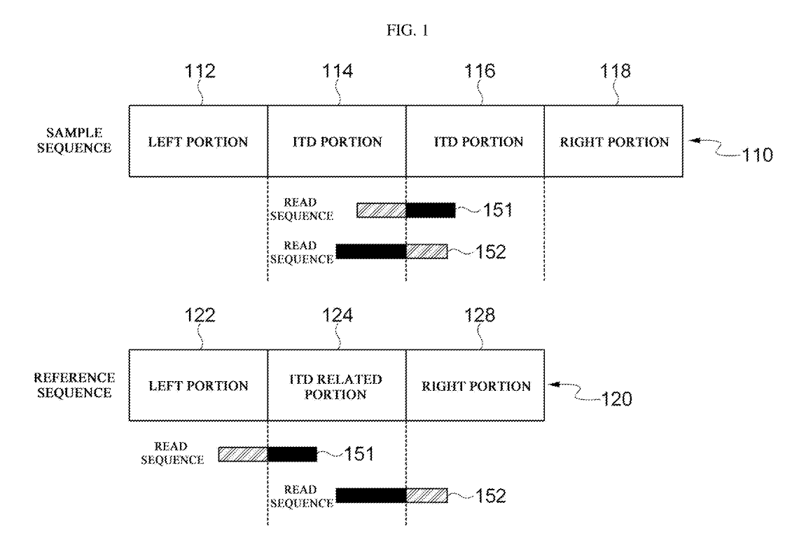

FIG. 1 is a view illustrating extracting read sequences from a DNA sample including ITD and mapping the extracted read sequences to a reference sequence.

As shown in FIG. 1, genetic information of a DNA sample in which ITD has occurred may be expressed by a sample sequence 110, which is a sequence of bases. The sample sequence 110 may include four base sequence portions 112, 114, 116, and 118. An ITD portion 114 and an ITD portion 116 exist between a left portion 112 and a right portion 118, wherein the ITD portion 116 is a base sequence portion which is the same as the ITD portion 114. The sample sequence 110 has been conceptually provided in advance for description, and it should be noted that a sample sequence is actually estimated through particular steps such as sequencing read sequences from a DNA sample and mapping the sequenced read sequences as will be described below.

A genome sequencer may extract a plurality of read sequences by having a DNA sample including an ITD mutation as an input. For example, a genome sequencer (e.g. HiSeq® sequencing platform) may read a DNA fragment in a 101 bp unit to generate a read sequence, and furthermore, use a paired-end method to extract a read sequence.

Next, extracted read sequences may be mapped to a reference sequence 120. As shown in FIG. 1, the reference sequence 120 may include three base sequence portions 122, 124, and 128. Particularly, a few read sequences may not be perfectly aligned with the reference sequence 120. Accordingly, the above mapping may involve differentiating a base sequence portion which does not match the reference sequence 120 (hereinafter, also called a nonmatching portion) from a base sequence portion which matches the reference sequence 120 (hereinafter, also called a matching portion) in each of the read sequences. According to some embodiments, the minimum length of the matching portion (i.e. the minimum number of bases in the matching portion) may be set in advance. For the mapping, a widely known alignment algorithm such as BWA or BWA-MEM having a soft clipping function may be used.

For convenience of description, let us assume that read sequences 151 and 152 have been output from a genome sequence, as shown in FIG. 1. Since the read sequences 151 and 152 originate from the ITD portions 114 and 116, each of the read sequences 151 and 152 may partially match the reference sequence 120 even if a left portion 122, an ITD-related portion 124, and a right portion 128 of the reference sequence 120 are respectively the same as the left portion 112, the ITD portion 114, and the right portion 118 of the sample sequence 110. For example, as shown in FIG. 1, an alignment algorithm may not be able to match a left portion (a portion indicated by diagonal lines) of the read sequence 151 with the reference sequence 120 while matching a right portion (a portion indicated by a shade) of the read sequence 151 with the ITD related portion 124. Likewise, the alignment algorithm may not be able to match a right portion (a portion indicated by diagonal lines) of the read sequence 152 with the reference sequence 120 while matching a left portion (a portion indicated by a shade) of the read sequence 152 with the ITD related portion 124.

Hereinafter, a method for detecting ITD of a genome sample from read sequences, each of which partially matches the reference sequence 120, will be described as an example. The method may generate a new reference sequence (hereinafter, also called “ITD reference sequence”) to detect ITD.

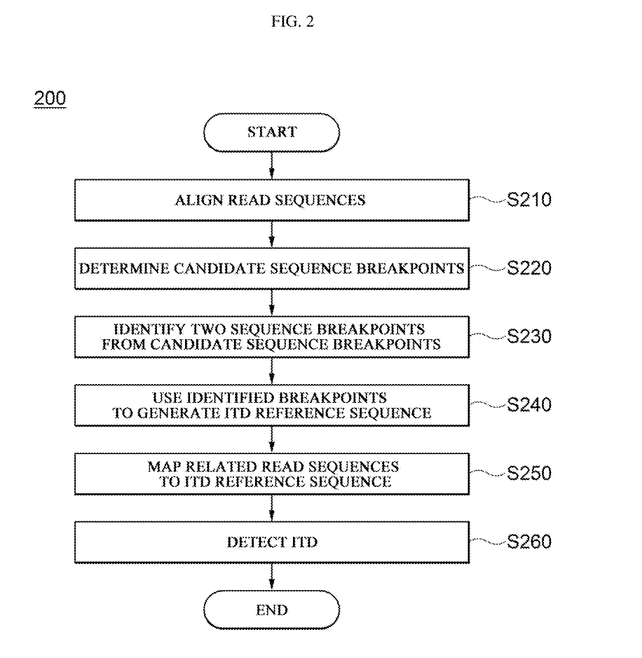

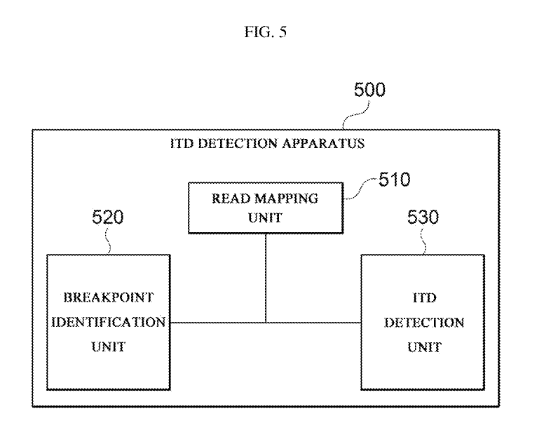

FIG. 2 is a flow chart illustrating a process of detecting ITD according to an illustrative embodiment. For example, a process 200 may be executed by an ITD detection apparatus 500 in FIG. 5.

After a start process step, the illustrative process 200 proceeds to a step S210. In the step S210, read sequences extracted from a genome sample by genome sequences are obtained, and the read sequences are mapped to the reference sequence 120. For the mapping, a proper algorithm among the alignment algorithms mentioned above may be selected.

In a step S220, candidate sequence breakpoints in the reference sequence 120 are determined. The determination may be based on read sequences which partially match the reference sequence 120 among read sequences output from a genome sequencer.

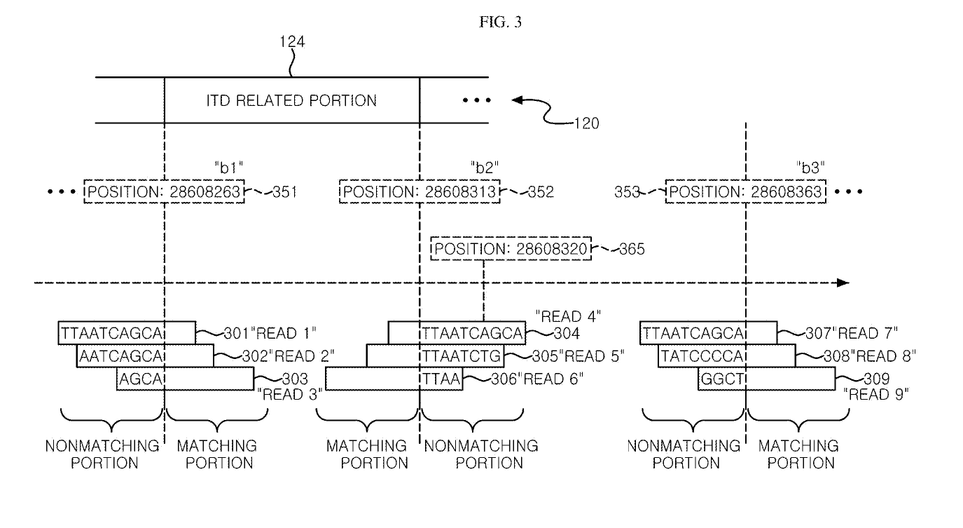

As an example, as shown in FIG. 3, a read sequence 301 has one end thereof positioned at a matching portion and the other end thereof positioned at a nonmatching portion. Eight other read sequences 302 to 309 shown in FIG. 3 are also the same.

Referring to FIG. 3, it may be recognized that one end of a matching portion of the read sequence 301 is mapped at a position 351 of a value called 28608263 and comes in contact with one end of a nonmatching portion of the read sequence 301 by mapping to the reference sequence 120. When a genome sequencer indicates the matching portion and the nonmatching portion while outputting the read sequence 301, the position 351 may be identified based on such an indication. In addition, an end which comes in contact with a nonmatching portion between two ends of a matching portion may be identified in the same way with respect to each of the eight other read sequences 302 to 309 mapped to the reference sequence 120. Accordingly, it may be confirmed that each of the two read sequences 302 and 303 has an end mapped at the position 351. Also, other positions 352 and 353 may be additionally identified based on the six remaining read sequences 304 to 309. Eventually, a matching portion of each of the read sequences 301 to 309 will have an end mapped at one of the identified positions 351, 352, and 353. Furthermore, whether the matching portion of each of the read sequences 301 to 309 exists in a forward direction (a direction from a preceding position to a trailing position, e.g. the right direction in FIG. 3) or a reverse direction (a direction from the trailing position to the preceding position, e.g. the left direction in FIG. 3) may be identified based on each of the identified positions.

To sum up, when the read sequences 301 to 309 have recorded numbers from “read 1” to “read 9”, respectively, information related to the identified positions 351, 352, and 353 is the same as that provided in the following table. The information may be maintained in a data structure (for example, in a table form). Even though the nine read sequences 301 to 309 have been shown in FIG. 3, other read sequences may be obtained from a genome sequence, and additional candidate sequence breakpoints may be determined based on the read sequences.

TABLE 1

| | Position in | Direction in which | |
|---|---|---|---|
| | Reference | Matching Portion is | Record Number of |
| ID | Sequence 120 | Positioned | Read Sequence |
| b1 | 28608263 | Forward | Read 1, . . . , Read 3 |
| b2 | 28608313 | Reverse | Read 4, . . . , Read 6 |
| b3 | 28608363 | Forward | Read 7, . . . , Read 9 |
| . . . | . . . | . . . | . . . |

Next, after confirming whether each of the positions identified as above is valid, the validated positions may be determined as candidate sequence breakpoints. For example, when each of the identified positions satisfies all of the following conditions, the positions may be viewed as being valid.
When a number of read sequences with an end of a matching portion mapped at an identified position (hereinafter, may be called read sequences “related” to the position, for convenience) is equal to or greater than a preset minimum number (for example, three)
When the length of the longest read sequence (i.e. a total number of bases in the read sequence) among the read sequences related to the position is equal to or greater than a preset minimum length (for example, five)
When “similarity of nonmatching portions” which represents an extent to which nonmatching portions of the read sequences related to the position are aligned with each other is equal to or greater than a preset critical value (for example, 0.9 or 90%)

In some embodiments, the similarity of nonmatching portions above may be a ratio of X with respect to Y, wherein Y represents a total number of all possible pairs of bases positioned in nonmatching portions and mapped at the same position in the reference sequence 120, and X represents a total number of pairs having the same bases among the all possible pairs. As an example, similarity of the read sequences 301 to 303 related to the position 351 is 16/16=100%. As another example, similarity of the read sequences 304 to 306 related to the position 352 is 15/16=93.75%. This is because a base of a nonmatching portion of the read sequence 305 is different from a base of a nonmatching portion of the read sequence 304 at a position 365 of a value called 28608320. As still another example, similarity of the read sequences 307 to 309 related to the position 353 is 8/16=50%. Consequently, the positions 351 and 352 may be determined as candidate sequence breakpoints.

Read sequences related to each of identified positions (for example, the positions 351, 352, and 353) may be identified among obtained read sequences (for example, the read sequences 301 to 309), and the identification may use information maintained in a data structure such as a form provided in Table 1.

In a step S230, two sequence breakpoints are identified from candidate sequence breakpoints. The identification may be based on a position difference between two sequence breakpoints. For example, two sequence breakpoints apart in an interval equal to or less than a preset maximum position difference may be identified among the candidate sequence breakpoints. Matching portions of read sequences related to a preceding sequence breakpoint of the two sequence breakpoints may be positioned in a forward direction, and matching portions of read sequences related to a trailing sequence breakpoint may be positioned in a reverse direction. For convenience of description, the following marks are assumed.
Each of the two identified sequence breakpoints are marked as bᵢ and bⱼ
A position of the sequence breakpoint bᵢ in the reference sequence 120
   is marked as pos{bᵢ}, and, likewise, a position of the sequence breakpoint bⱼ in the reference sequence 120 is marked as pos{bⱼ}
The preset maximum position difference is marked as MaxITDLength
   (in other words, when pos{bᵢ} is less than pos{bⱼ}, pos{bⱼ}−pos{bᵢ}≦MaxITDLength)
The reference sequence 120 is marked as S
A base sequence portion positioned in the reference sequence 120 and
   spanning from a first position in the reference sequence 120 to a second position in the reference sequence 120 is marked as S[first position, second position]
A variable which represents a number of times in which a base sequence portion positioned in the reference sequence 120 and spanning from one of the two sequence breakpoints to the other one, i.e. S[pos{bᵢ}, pos{bⱼ}], is to be included in the ITD reference sequence 120 is marked as k (here, pos{bᵢ} is less than pos{bⱼ})
Concatenation of k base sequence portions, each of which is the same base sequence portion S[pos{bᵢ}, pos{bⱼ}], is marked as k*S[pos{bᵢ}, pos{bⱼ}]

In a step S240, an ITD reference sequence is generated based on the two identified sequence breakpoints. For example, the ITD reference sequence may be generated to include concatenation of the following three base sequence portions. The base sequence portions may appear in accordance with an order provided below in the concatenation. Two variables LeftFlankingLength and RightFlankingLength appearing below may be properly set to generate the ITD reference sequence.
S[pos{bᵢ}−LeftFlankingLength, pos{bⱼ}−1]
k*S[pos{bᵢ}, pos{bⱼ}]
S[pos{bᵢ}+1, pos{bⱼ}+RightFlankingLength]

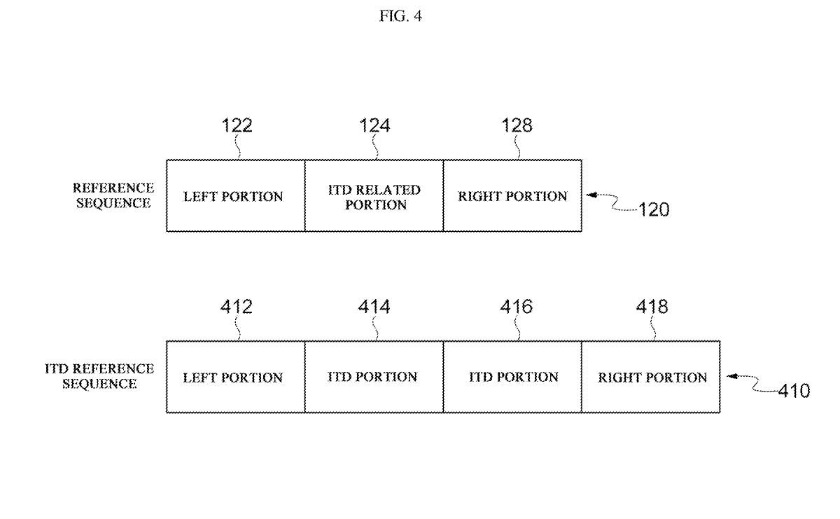

As an example, when the sequence breakpoints bᵢ and bⱼ are the position 351 and the position 352, respectively, and an initial value of k is set as 2, a generated ITD reference sequence may be an ITD reference sequence 410 in FIG. 4. As shown in FIG. 4, the ITD reference sequence 410 may include the ITD related portion 124 of the reference sequence 120 as an ITD portion 414 between a left portion 412 and a right portion 418, and include a sequential repetition of the ITD related portion 124 as an ITD portion 416. In addition, the ITD reference sequence 410 may include the left portion 122 of the reference sequence 120 as the left portion 412, and include the right portion 128 of the reference sequence 120 as the right portion 418.

In a step S250, read sequences related to the identified sequence breakpoints may be mapped to the ITD reference sequence. A mapping result may be generated by the mapping. The generating of the mapping result may include calculating mapping similarity which represents an extent to which the related read sequences match the ITD reference sequence. According to some embodiments, the mapping similarity may be calculated based on: (i) the length of each of the read sequences; and (ii) the length of a portion matching the ITD reference sequence or a portion not matching the ITD reference sequence in each of the read sequences. For example, a mismatch ratio may be calculated with respect to each of the read sequences, wherein the ratio may be a value obtained by dividing the length of a portion positioned in each of the read sequences and not matching the ITD reference sequence by the length of each of the read sequences.

In a step S260, whether ITD is present in a genome sample is determined. The determination may be based on the result of mapping the related read sequences to the ITD reference sequence. For example, when a total number of read sequences with the mismatch ratio equal to or less than a particular value exceeds a preset critical value, it is determined that ITD is present in a genome sample. Accordingly, an ITD mutation included in the genome sample (for example, genomic variation expressed with the ITD portions 114 and 116 in the sample sequence 110) may be detected. As an example, when the positions 351 and 352 in FIG. 3 are identified as two sequence breakpoints bᵢ and bⱼ, and all of the mismatch ratios of each of the read sequences 301 to 306 related to the sequence breakpoints 351 and 352 are less than a particular critical value, a base sequence portion spanning between the two sequence breakpoints 351 and 352 in the reference sequence 120 (i.e. the ITD related portion 124) may be viewed as genetic information which represents the ITD mutation.

If it is determined in the step S260 that ITD is not present in a genome sample with the initial value of k as 2, the process 200 may involve repeating the following steps after increasing the k (for example, by 1).
Generating an ITD reference sequence again (S240)
Mapping the read sequences related to the identified sequence breakpoints to a new ITD reference sequence (S250)
Attempting to detect ITD in a genome sample (S260)

The steps above may be repeated until ITD is detected. However, according to some embodiments, when k exceeds a particular maximum number of possible times (for example, when multiplication of the length of S[pos{bᵢ}, pos{bⱼ}] and k is greater than twice the length of a read sequence mapped to an ITD reference sequence), the steps above may end.

According to some embodiments, when ITD is detected, a process of estimating a ratio R of cells having ITD among all cells is as follows. With respect to each of the sequence breakpoints, obtain a number of reads, N₁, which perfectly match an ITD reference sequence. Obtain a number of reads, N₂, related to each of the sequence breakpoints. Then, R may be calculated by N₂/(N₁+N₂).

FIG. 5 illustrates an ITD detection apparatus according to an illustrative embodiment.

As shown in FIG. 5, the illustrative ITD detection apparatus 500 includes a read mapping unit 510, a breakpoint identification unit 520, and an ITD detection unit 530. For example, the ITD detection apparatus 500 may be implemented or included in a computing apparatus. According to some embodiments, each component of the ITD detection apparatus 500 may be implemented by hardware (e.g. a processor, a memory, an input-output interface etc.) of the computing apparatus. The computing apparatus may include one or more processors and a computer readable storage medium such as a memory which can be accessed by the one or more processors. The computer readable storage medium may be disposed at an inside or outside of the one or more processors, and connected to the one or more processors by various well-known means. Computer executable instructions may be stored in the computer readable storage medium. The one or more processors may execute the instructions stored in the computer readable storage medium. When executed by the one or more processors, the instructions may enable the one or more processors to perform steps according to an illustrative embodiment.

The read mapping unit 510 may receive reads sequenced from a genome sample and map the received reads to a reference genome sequence. The alignment algorithm mentioned above may be used for the mapping.

A plurality of reads which partially match the reference genome sequence may be present among the reads. Particularly, the read mapping unit 510 may identify a matching portion and a nonmatching portion of each of the partially matching reads as above by mapping to the reference genome sequence. Both ends of the reads may be positioned at the matching portion and the nonmatching portion, respectively.

The breakpoint identification unit 520 may obtain the plurality of reads with the matching portion and the nonmatching portion identified as above (in other words, each read partially matches the reference genome sequence). The breakpoint identification unit 520 may identify two sequence breakpoints (may be shortened and also be called “breakpoint”) in the reference genome sequence based on the plurality of obtained reads.

For example, the breakpoint identification unit 520 may identify a plurality of positions in the reference genome sequence based on the plurality of obtained reads to determine candidate breakpoints, wherein one end of a matching portion of each of the reads may be mapped at one of the identified positions. According to some embodiments, the breakpoint identification unit 520 may determine each of the candidate breakpoints as a corresponding position among the identified positions, wherein the determination may be based on a total number of reads related to the position (i.e. reads having ends mapped at the position) among the plurality of reads, the length of the longest related read among the related reads, and similarity of nonmatching portions. The similarity of nonmatching portions may be calculated by a ratio with respect to (i) a total number of all possible pairs having a first base positioned in one nonmatching portion of the related reads and a second base positioned in another nonmatching portion of the related reads (here, the first base and the second base are mapped at the same position in the reference genome sequence) of (ii) a total number of the same base pairs among the all possible pairs. Next, the breakpoint identification unit 520 may identify two breakpoints with a position difference smaller than a preset value among the candidate breakpoints.

The ITD detection unit 530 may generate an ITD reference sequence which includes a base sequence portion spanning between the two breakpoints above in the reference genome sequence and a sequential repetition of the base sequence portion Next, the read mapping unit 510 may map the reads related to the identified breakpoints (in other words, a matching portion of each of the reads has an end mapped at one of the two breakpoints) to the ITD reference sequence to generate a mapping result (e.g. mapping similarity mentioned above). The ITD detection unit 530 may detect an ITD mutation in a genome sample based on the mapping result. If ITD has not been detected by the generated ITD reference sequence, the ITD detection unit 530 may include one or more different sequential repetitions of the base sequence portion between the two breakpoints in the ITD reference sequence, and repeat mapping the reads related to the breakpoints to the ITD reference sequence changed as above.

Meanwhile, a predetermined embodiment may include a computer readable storage medium including a program for performing the process described in the present specification on a computer. The computer readable storage medium may include a program instruction, a local data file, a local data structure, and so on individually or in combination. The computer readable storage media may be those designed and configured particularly for the preset disclosure. As an example of the computer readable storage media, magnetic media such as a hard disk, a floppy disk, and a magnetic tape, optical recording media such as compact disk read-only memory (CD-ROM) and digital versatile disk (DVD), magnetic-optical media such as a floptical disk, and hardware devices such as read-only memory (ROM), random-access memory (RAM), and flash memory which are particularly configured to store and execute program instructions are included. As an example of the program instructions, not only machine codes which are the same as those formed by a compiler, but also high-level language codes which may be executed by a computer using an interpreter etc. may be included.

Predetermined embodiments have provided a method for detecting ITD included in a genome sample more promptly and accurately in a process of aligning base sequence fragments sequenced from a genome sample (e.g. a DNA sample) by a NGS sequencer.

According to predetermined embodiments, the length of an ITD mutation can be measured with higher accuracy.

According to predetermined embodiments, a ratio of cells having ITD in a sample to be sequenced by a NGS method can be effectively estimated.

The method for detecting ITD according to predetermined embodiments can not only be applied to a FLT3 gene, but also to other genes.

Illustrative embodiments of the preset disclosure have been described in detail in the above, but those of ordinary skill in the art to which the preset disclosure pertains will understand that various modifications are possible without departing from the scope of the preset disclosure. Therefore, the scope of the preset disclosure should not be defined as being limited to the embodiments described above, but should be defined by claims below and their equivalents.

What is claimed is:

1. An internal tandem duplication (ITD) detection apparatus, comprising:
a breakpoint identification unit configured to identify two breakpoints in a reference genome sequence based on a plurality of reads, each of the plurality of the reads partially matches the reference genome sequence; and
an ITD detection unit configured to generate an ITD reference sequence which comprises a base sequence portion spanning between the two breakpoints in the reference genome sequence and a sequential repetition of the base sequence portion.

2. The ITD detection apparatus of claim 1, further comprising a read mapping unit configured to map the plurality of reads to the reference genome sequence to identify a matching portion and a nonmatching portion of each of the plurality of reads,
wherein the matching portion matches the reference genome sequence, and the nonmatching portion does not match the reference genome sequence.

3. The ITD detection apparatus of claim 2, wherein both ends of each of the plurality of reads are positioned at the matching portion and the nonmatching portion, respectively.

4. The ITD detection apparatus of claim 2, wherein:
the read mapping unit also maps a plurality of related reads among the plurality of reads to the ITD reference sequence to generate a mapping result; and
one end of a matching portion of each of the plurality of related reads is mapped at one of the two breakpoints.

5. The ITD detection apparatus of claim 4, wherein the read mapping unit generates the mapping result based on a length of each of the plurality of related reads and a length of one portion of each of the plurality of related reads, and
the one portion does not match the ITD reference sequence.

6. The ITD detection apparatus of claim 4, wherein the breakpoint identification unit also obtains the plurality of reads sequenced from a genome sample, and
the ITD detection unit also detects an ITD mutation in the genome sample based on the mapping result.

7. The ITD detection apparatus of claim 4, wherein the ITD detection unit also changes the ITD reference sequence by including at least one different sequential repetition of the base sequence portion in the ITD reference sequence, and
the read mapping unit also repeats mapping of the plurality of related reads with respect to the changed ITD reference sequence.

8. The ITD detection apparatus of claim 2, wherein the breakpoint identification unit also identifies a plurality of positions in the reference genome sequence based on the plurality of reads to determine a plurality of candidate breakpoints in the reference genome sequence, and
the matching portion of each of the plurality of reads has an end mapped at one of the plurality of positions.

9. The ITD detection apparatus of claim 8, wherein the breakpoint identification unit determines each of the plurality of candidate breakpoints as a corresponding position among the plurality of positions based on:
a total number of related reads among the plurality of reads;
a length of the longest related read among the related reads;
a total number of all possible pairs each having a first base positioned in one nonmatching portion of the related reads and a second base positioned in another nonmatching portion of the related reads; and
a total number of the same base pairs among the all possible pairs, and
each of the related reads has an end mapped at the corresponding position, and the first base and the second base are mapped at the same position in the reference genome sequence.

10. The ITD detection apparatus of claim 8, wherein the breakpoint identification unit identifies the two breakpoints among the plurality of candidate breakpoints based on a position difference between the two breakpoints.

11. A method for detecting internal tandem duplication (ITD), the method comprising:
identifying two breakpoints in a reference genome sequence based on a plurality of reads, each of the plurality of reads partially matches the reference genome sequence; and
generating an ITD reference sequence which comprises a base sequence portion spanning between the two breakpoints in the reference genome sequence and a sequential repetition of the base sequence portion.

12. The method of claim 11, further comprising mapping the plurality of reads to the reference genome sequence to identify a matching portion and a nonmatching portion of each of the plurality of reads,
wherein the matching portion matches the reference genome sequence, and the nonmatching portion does not match the reference genome sequence.

13. The method of claim 12, wherein both ends of each of the plurality of reads are positioned at the matching portion and the nonmatching portion, respectively.

14. The method of claim 12, further comprising mapping a plurality of related reads among the plurality of reads to the ITD reference sequence to generate a mapping result,
wherein one end of the matching portion of each of the plurality of related reads is mapped at one of the two breakpoints.

15. The method of claim 14, wherein the mapping of the plurality of related reads comprises generating the mapping result based on a length of each of the plurality of related reads and a length of one portion of each of the plurality of related reads, and
the one portion does not match the ITD reference sequence.

16. The method of claim 14, further comprising obtaining the plurality of reads sequenced from a genome sample, and detecting an ITD mutation in the genome sample based on the mapping result.

17. The method of claim 14, further comprising changing the ITD reference sequence by including at least one different sequential repetition of the base sequence portion in the ITD reference sequence, and
repeating mapping of the plurality of related reads with respect to the changed ITD reference sequence.

18. The method of claim 12, wherein the identifying of the two breakpoints comprises identifying a plurality of positions in the reference genome sequence based on the plurality of reads to determine a plurality of candidate breakpoints in the reference genome sequence, and
the matching portion of each of the plurality of reads has an end mapped at one of the plurality of positions.

19. The method of claim 18, wherein the identifying of the two breakpoints further comprises determining each of the plurality of candidate breakpoints as a corresponding position among the plurality of positions based on:
a total number of related reads among the plurality of reads;
the length of the longest related read among the related reads;
a total number of all possible pairs each having a first base positioned in one nonmatching portion of the related reads and a second base positioned in another nonmatching portion of the related reads; and
a total number of the same base pairs among the all possible pairs, and
each of the related reads has an end mapped at the corresponding position, and the first base and the second base are mapped at the same position in the reference genome sequence.

20. The method of claim 18, wherein the identifying of the two breakpoints further comprises identifying the two breakpoints among the plurality of candidate breakpoints based on a position difference between the two breakpoints.

21. A computer program combined with hardware and stored in a medium to execute the method described in claim 11.
